(19) United States
(12) Patent Application Publication
(10) Pub. No.: US 2025/0274635 A1
(43) Pub. Date: Aug. 28, 2025

(54) Mobile Application for Children's Content Moderation Device

(71) Applicant: Hannah Gibson, Roundup, MT (US)

(72) Inventor: Hannah Gibson, Roundup, MT (US)

(21) Appl. No.: 19/007,825

(22) Filed: Jan. 2, 2025

Related U.S. Application Data
(60) Provisional application No. 63/556,933, filed on Feb. 23, 2024.

(51) Int. Cl. H04N 21/45; H04N 21/482

(52) U.S. Cl. CPC H04N 21/4532; H04N 21/4825

(57) ABSTRACT

A content moderation application device is disclosed, which is a mobile software application or website that allows a parental user to moderate content universally over a plurality of streaming services. The mobile software application allows a user to create filtered watchlists for different users. The mobile software application allows a user to create a secure pin to protect the content settings. A user would download the mobile application and utilize the user interface to create settings that ban child users from specific content, streaming surfaces, and programs.

### CROSS-REFERENCE TO RELATED APPLICATION

The present application claims priority to, and the benefit of, U.S. Provisional Application No. 63/556,933, which was filed on Feb. 23, 2024, and is incorporated herein by reference in its entirety.

### FIELD OF THE INVENTION

The present invention relates generally to the field of content moderation application devices. More specifically, the present invention relates to a software application or mobile application for allowing a parental user to moderate content universally over a plurality of streaming services. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in content moderation application devices. Generally, in today's digital age, many forms of content are not child friendly. As a result, many streaming applications and services allow a parental user to restrict content on the applications for children. However, this must be done for every individual streaming service, which is burdensome and time-consuming to set up.

Further, sometimes children can get into the streaming service and change the restricted controls, allowing them to watch anything they want. Moreover, besides restricting specific shows, it would be useful to be able to create entire watchlists for children.

Accordingly, there is a demand for an improved content moderation application device that allows users to moderate content universally over a plurality of streaming services. More particularly, there is a demand for a content moderation application device that allows users to create custom watchlists for different users.

Therefore, there exists a long-felt need in the art for a content moderation application device that provides users with a means for moderating content for their children. There is also a long-felt need in the art for a content moderation application device that is a mobile application on a parental user's smart device. Further, there is a long-felt need in the art for a content moderation application device that allows a parental user to moderate content universally over a plurality of streaming services. Moreover, there is a long-felt need in the art for a device that allows users to create filtered watchlists for children across various streaming platforms. Further, there is a long-felt need in the art for a content moderation application device that allows a user to create a secure pin to protect the settings. Finally, there is a long-felt need in the art for a content moderation application device that allows a user to ban specific content, streaming surfaces, and programs.

The subject matter disclosed and claimed herein, in one embodiment thereof, comprises a content moderation application device. The device is a mobile software application or website that allows a parental user to moderate content universally over a plurality of streaming services. The mobile software application allows a user to create filtered watchlists for different users. The mobile software application allows a user to create a secure pin to protect the content settings. A user would download the mobile application and utilize the user interface to create settings that ban child users from specific content, streaming surfaces, and programs.

In this manner, the content moderation application device of the present invention accomplishes all of the forgoing objectives and provides users with a mobile application for controlling content across a plurality of streaming services. The device is a mobile application that can be downloaded on a user's smart device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a content moderation application device. The device is a mobile software application or website that allows a parental user to moderate content universally over a plurality of streaming services. The mobile software application allows a user to create filtered watchlists for different users. The mobile software application allows a user to create a secure pin to protect the content settings. A user would download the mobile application and utilize the user interface to create settings that ban child users from specific content, streaming surfaces, and programs.

In one embodiment, the content moderation application device utilizes a smartphone, a tablet, a laptop, a smart television, or a desktop computer, etc., or any other suitable electronic device that has the required operating and memory parameters to support the software application of the present invention.

In one embodiment, once downloaded, the software application allows a user to create a secure PIN to protect the content settings. The PIN can be a four or six digit PIN chosen by the user. The PIN prevents unauthorized users from going into the software application and changing the content settings.

In one embodiment, the software application allows users to perform several actions which can be applied to multiple streaming services to moderate content settings. These actions include, but are not limited to, blocking shows and streaming services, setting screen time limits, setting rating limits, and setting a screen time tracker, etc. Thus, users can block specific shows and/or an entire streaming service from a child. Users can also set screen time limits and can enable trackers to track screen time use. Further, users can set rating limits, allowing users to access shows that have a specific rating.

In one embodiment, the software application allows a user to utilize several parameters to moderate content settings. These parameters include, but are not limited to, specific streaming services, rating or genre, etc. Thus, users can select what streaming services to limit access of. Then, users can select specific ratings or genre to further limit shows within the streaming services.

In one embodiment, the software application allows users to create filtered watchlists for children across various streaming platforms. The watchlists can be customized via various parameters. Further, the software application allows users to create custom watchlists for different users. The software application can then display the various watchlists, which are identified by user. Thus, the software application allows users to ban specific content, streaming services, and programs/shows.

In one embodiment, the mobile or software application provides a secure website and/or smart phone app access by users for content moderation of multiple streaming services. In addition to these elements, the device of the present invention may also include: a web server and Cloud database of streaming services identification and data connectable to the mobile smartphone or portable tablet or computer device, etc.

In one embodiment of the invention, the streaming services identification and data management software is maintained on a Microsoft Cloud server in a typical fashion, or other cloud server, such as the Adobe, Apple or Amazon cloud server, etc. A secure cloud server is used for the protection and security of streaming services identification and data stored on the cloud server. Thus, streaming services identification and data, as well as multiple restricted parameters, is sent to the cloud server and collected. Conveniently, the data is stored and managed with a data management software or program to manage the collected streaming services identification and data, etc.

Typically, a cellular wireless data network embedded in the computer, tablet, smart television, or smartphone, etc., transmits both streaming services identification and data to a user and/or cloud server. Such streaming services identification and data can be processed by the user via a Cloud data management server.

In yet another embodiment, the content moderation application device comprises a plurality of indicia.

In yet another embodiment, a method of moderating content universally over a plurality of streaming services using a mobile application is disclosed. The method includes the steps of providing a content moderation application device comprising a software application or mobile application. The method also comprises downloading or installing the software/mobile application on a smart device. Further, the method comprises creating a secure PIN on the software/mobile application. The method also comprises moderating content across multiple streaming services. Finally, the method comprises creating customized watchlists for different users.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the content moderation application device of the present invention showing the home page for inserting a PIN in accordance with the disclosed architecture;

FIG. 2 illustrates a perspective view of one embodiment of the content moderation application device of the present invention showing the different limitations that can be applied to various streaming services in accordance with the disclosed architecture;

FIG. 3 illustrates a perspective view of one embodiment of the content moderation application device of the present invention showing how a user can create a custom watchlist for a specific child in accordance with the disclosed architecture;

FIG. 4 illustrates a perspective view of one embodiment of the content moderation application device of the present invention showing the different streaming services available for restricting content in accordance with the disclosed architecture;

FIG. 5 illustrates a perspective view of one embodiment of the content moderation application device of the present invention showing the customized watchlists for different users in accordance with the disclosed architecture;

FIG. 6 illustrates a flowchart showing the method of moderating content universally over a plurality of streaming services using a mobile application in accordance with the disclosed architecture;

FIG. 7 is a schematic diagram illustrating one embodiment of the software application for moderating content of streaming services of the present invention in accordance with the disclosed architecture; and

FIG. 8 illustrates an exemplary user device that is used for installing the software application for moderating content of streaming services of the present invention for communication with a server system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a content moderation application device that provides users with a means for moderating content for their children. There is also a long-felt need in the art for a content moderation application device that is a mobile application on a parental user's smart device. Further, there is a long-felt need in the art for a content moderation application device that allows a parental user to moderate content universally over a plurality of streaming services. Moreover, there is a long-felt need in the art for a device that allows users to create filtered watchlists for children across various streaming platforms. Further, there is a long-felt need in the art for a content moderation application device that allows a user to create a secure pin to protect the settings. Finally, there is a long-felt need in the art for a content moderation application device that allows a user to ban specific content, streaming surfaces, and programs.

The present invention, in one exemplary embodiment, is a novel content moderation application device. The device is a mobile software application or website that allows a parental user to moderate content universally over a plurality of streaming services. The mobile software application allows a user to create filtered watchlists for different users. The mobile software application allows a user to create a secure pin to protect the content settings. A user would download the mobile application and utilize the user interface to create settings that ban child users from specific content, streaming surfaces, and programs. The present invention also includes a novel method of moderating content universally over a plurality of streaming services using a mobile application. The method includes the steps of providing a content moderation application device comprising a software application or mobile application. The method also comprises downloading or installing the software/mobile application on a smart device. Further, the method comprises creating a secure PIN on the software/mobile application. The method also comprises moderating content across multiple streaming services. Finally, the method comprises creating customized watchlists for different users.

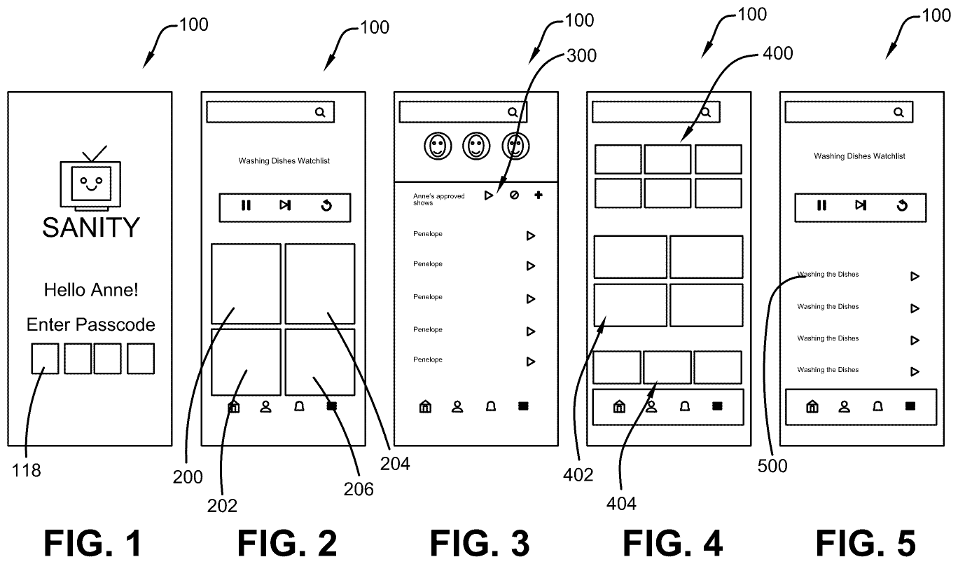

Referring initially to the drawings, FIGS. 1-5 illustrate a perspective view of one embodiment of the content moderation application device 100 of the present invention. In the present embodiment, the content moderation application device 100 is an improved content moderation application device 100 that provides a user with a software application, mobile application, or website that allows users to universally moderate content over multiple streaming services. The device 100 is a mobile software application or website that will help users ban specific content and programs across multiple streaming services. Specifically, the device 100 is a unique software application accessible on a smartphone, tablet, laptop, smart television or a desktop computer (i.e., user device 102). The mobile software application device 100 will allow a user to moderate content across a variety of streaming services. The mobile software application device 100 provides a user interface to allow a user to ban specific content and programs, as well as create customized watchlists. A user would download the mobile application and utilize the user interfaces to moderate content via various parameters, as needed.

Further, the content moderation application device 100 utilizes a smartphone, a tablet, a laptop, a smart television or a desktop computer, etc. (i.e., user device 102), or any other suitable electronic device that has the required operating and memory parameters to support the software application of the present invention.

As shown in FIG. 1, once downloaded, the software application allows a user to create a secure PIN 118 to protect the content settings. The PIN 118 can be a four or six digit PIN chosen by the user. The PIN 118 prevents unauthorized users from going into the software application and changing the content settings.

As shown in FIG. 2, the software application allows users to perform several actions which can be applied to multiple streaming services to moderate content settings. These actions include, but are not limited to, blocking shows and streaming services 200, setting screen time limits 202, setting rating limits 204, and setting a screen time tracker 206, etc. Thus, users can block specific shows and/or an entire streaming service from a child. Users can also set screen time limits and can enable trackers to track screen time use. Further, users can set rating limits, allowing users to access shows that have a specific rating.

As shown in FIG. 4, the software application allows a user to utilize several parameters to moderate content settings. These parameters include, but are not limited to, specific streaming services 400, rating 402 or genre 404, etc. Thus, users can select what streaming services 400 to limit access of. Then, users can select specific ratings 402 or genre 404 to further limit shows within the streaming services 400. Streaming services 400 can include Netflix, Hulu, Disney+, Amazon Prime Video, Apple TV, YouTube, etc. Ratings 402 can include Y for children, G for general audiences, PG for parental guidance, and R for people 17 years and older. Genre 404 can include mysteries, cartoons, comedy, drama, etc.

As shown in FIGS. 3 and 5, the software application allows users to create filtered watchlists 300 for children across various streaming platforms. The watchlists 300 can be customized via various parameters. Further, the software application allows users to create custom watchlists 300 for different users. The software application can then display the various watchlists 300, which are identified by user. Thus, the software application allows users to ban specific content, streaming services, and programs/shows.

Generally, the mobile or software application provides a secure website and/or smart phone app access by users for content moderation of multiple streaming services. In addition to these elements, the device 100 of the present invention may also include: a web server/application server 108 and Cloud database 110 of streaming services identification and data connectable to the mobile smartphone or portable tablet or computer device 102, etc.

In one embodiment of the invention, the streaming services identification and data management software is maintained on a Microsoft Cloud server in a typical fashion, or other cloud server, such as the Adobe, Apple or Amazon cloud server, etc. A secure cloud server is used for the protection and security of streaming services identification and data stored on the cloud server. Thus, streaming services identification and data, as well as multiple restricted parameters, is sent to the cloud server and collected. Conveniently, the data is stored and managed with a data management software or program to manage the collected streaming services identification and data, etc.

Typically, a cellular wireless data network 106 embedded in the computer, tablet, smart television or smartphone, etc. (i.e., user device 102), transmits both streaming services identification and data to a user and/or cloud server. Such streaming services identification and data can be processed by the user via a Cloud data management server.

In yet another embodiment, the content moderation application device 100 comprises a plurality of indicia 500. Specifically, the software application of the device 100 may include advertising, a trademark, or other letters, designs, or characters, printed, painted, stamped, or integrated into the software application, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be streaming service, content, or brand related.

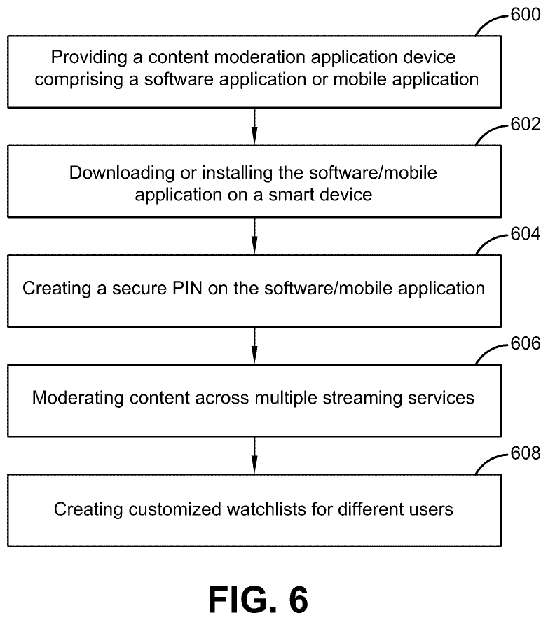

FIG. 6 illustrates a flowchart of the method of moderating content universally over a plurality of streaming services using a mobile application. The method includes the steps of at 600, providing a content moderation application device comprising a software application or mobile application. The method also comprises at 602, downloading or installing the software/mobile application on a smart device. Further, the method comprises at 604, creating a secure PIN on the software/mobile application. The method also comprises at 606, moderating content across multiple streaming services. Finally, the method comprises at 608, creating customized watchlists for different users.

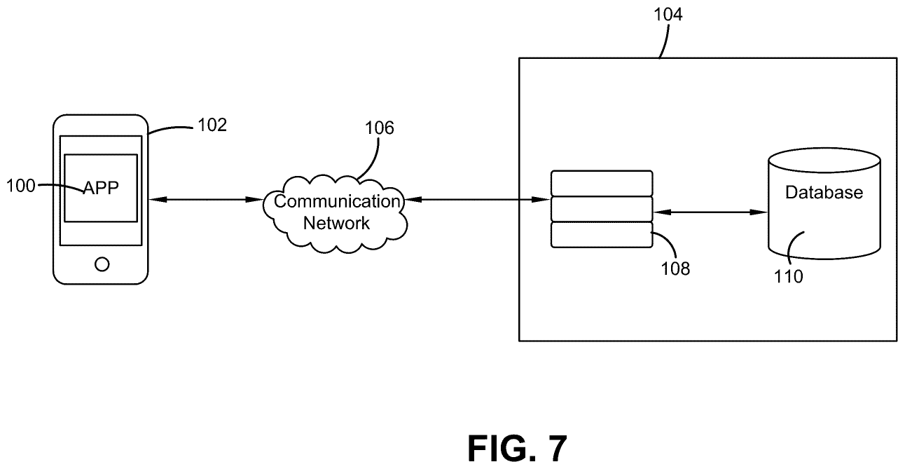

FIG. 7 is a schematic diagram illustrating one embodiment of the software application for moderating content 100 of the present invention. The application 100 has a client-server architecture wherein a user accesses the application 100 installed on a user device 102. The application 100 also comprises a server system 104 and the user device 102 is communicatively coupled to the server system 104 via a communication network 106, such as the Internet. The user device 102 is capable of facilitating a user to input data, receive data, and/or transmit data within the application 100. It will be apparent to a user of ordinary skill in the art that the user may be any personnel using the application 100, without deviating from the scope of the disclosure. Examples of the user device 102 may include, but are not limited to, a desktop, a notebook, a laptop, a handheld computer, a touch sensitive device, a tablet, a computing device, a smart-phone, and/or a smart watch, etc., or any other suitable device as is known in the art.

The server system 104 is a network of computers, a software framework, or a combination thereof, that may provide a generalized approach to creating the server implementation. More specifically, the server system 104 includes an application server 108 and one or more associated databases 110. The application server 108 and the databases 110 can be integrated as a single unit or can be coupled to each other through a network. Examples of the application server 108 may include, but are not limited to, personal computers, laptops, mini-computers, mainframe computers, any non-transient and tangible machine that can execute a machine-readable code, cloud-based servers, distributed server networks, or a network of computer systems, etc. The application server 108 can be realized through various web-based technologies such as, but not limited to, a Java web-framework, a .NET framework, a personal home page (PHP) framework, or any web-application framework, etc. The server system 104 can be maintained by a storage facility management authority or a third-party entity that facilitates service enablement and resource allocation operations of the application 100.

The application server 108 is configured to have the logic, instructions, circuitry, interfaces, and/or codes for executing various operations required for communication between the server 108 and the user device 102 and also between the databases 110 and the server 108. The databases 110 are configured to store therein, data associated with the deceased birthdates, death dates, names, cemetery where buried, location of gravesite, etc., from the application 100. In some embodiments, a set of centralized or distributed network of peripheral memory devices may be interfaced with the server 104, as an example, on a cloud server.

The communication network 106 may include suitable logic, circuitry, and interfaces that may be configured to provide a plurality of network ports and a plurality of communication channels for transmission and reception of data related to operations of various entities (such as the user device 102 and the server system 104) of the application 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 106 may be associated with an application layer for implementation of communication protocols based on one or more communication requests from the user device 102 and the server system 104. The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel or a plurality of communication channels in the communication network 106. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

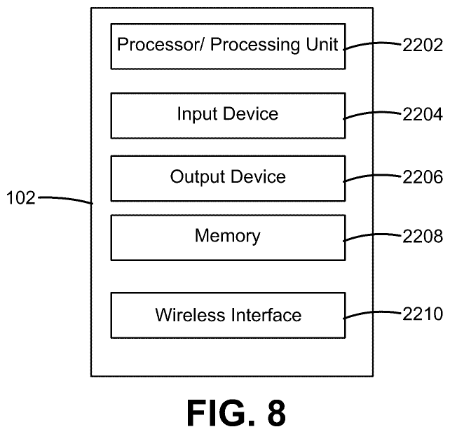

FIG. 8 illustrates an exemplary user device 102 that is used for installing the software application 100 of the present invention. The processing unit 2202 may include suitable logic, instructions, circuitry, interfaces, and/or codes for executing various operations, such as the operations associated with the user device 102, etc. The processing unit 2202 may be configured to control one or more operations executed by the user device 102 in response to the input received at the user device 102 from the user. The processor 2202 executes the computer readable instructions stored in the software application. Examples of the processing unit 2202 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), etc. Embodiments of the present disclosure are intended to include or otherwise cover any type of processing unit 2202 including known, related art, and/or later developed processing units. The user device 102 can further include one or more computer executable applications configured to be executed by the processing unit 2202. The one or more computer executable applications may include suitable logic, instructions, and/or codes for executing various operations. The one or more computer executable applications may be stored in the memory 2208. The one or more computer executable applications includes the software application 100.

The user device 102 comprises input device(s) 2204, such as a touch input device, a voice input device, etc., for entering data and information. Preferably, the touch interface of the user device 102 is used as the input and various buttons/tabs shown on the software application are pressed or clicked by the user.

Electronic device 102 also comprises a memory 2208 used for storing programs (sequences of instructions) or data (i.e., program state information) on a temporary or permanent basis for use in the computer system. Memory 2208 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 2202, in combination with one or more of memory 2208, input device(s) 2204, and output device(s) 2206 is utilized to allow users to execute instructions on the application 100. The connection to a network is provided by wireless interface 2210.

The wireless interface 2210 enables the user device 102 to communicate with the server 104 and other components of the application 100 over the communication network 106, according to embodiments of the present disclosure. Examples of the communication interface 2210 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit, etc. It will be apparent to a user of ordinary skill in the art that the communication interface 2210 may include any device and/or apparatus capable of providing wireless or wired communications between the user device 102 and the server 104.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “content moderation application device”, “software application device”, “content application device”, and “device” are interchangeable and refer to the content moderation application device 100 of the present invention.

Notwithstanding the forgoing, the content moderation application device 100 of the present invention can be of any suitable size and configuration as is known in the art without affecting the overall concept of the invention, provided that it accomplishes the above stated objectives. One of ordinary skill in the art will appreciate that the content moderation application device 100 as shown in FIGS. 1-8 is for illustrative purposes only, and that many other sizes and shapes of the content moderation application device 100 are well within the scope of the present disclosure. Although the dimensions of the content moderation application device 100 are important design parameters for user convenience, the content moderation application device 100 may be of any size that ensures optimal performance during use and/or that suits the user's needs and/or preferences.

Various moderations and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, moderations, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, moderations and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A content moderation application device that allows users to moderate content over multiple streaming services, the content moderation application device comprising:
a software application;
wherein the software application is accessible on a smart device; and
further wherein a user utilizes the software application to moderate content universally over a plurality of streaming services.

2. The content moderation application device of claim 1, wherein the smart device is a smartphone, tablet, laptop, or a desktop computer.

3. The content moderation application device of claim 2, wherein the software application allows a user to create a secure PIN.

4. The content moderation application device of claim 3, wherein the software application allows a user to create filtered watchlists for children across various streaming platforms.

5. The content moderation application device of claim 4, wherein the software application allows a user to create custom watchlists for different users.

6. The content moderation application device of claim 5, wherein the software application allows users to block shows and streaming services, set screen time limits, set rating limits, and set a screen time tracker.

7. The content moderation application device of claim 6, wherein the software application allows users to utilize several parameters to moderate content settings, such as specific streaming services, ratings, or genres.

8. The content moderation application device of claim 7, wherein the software application provides secure website or smart phone application access by users for content moderation.

9. The content moderation application device of claim 8 further comprising a web server and a Cloud database of streaming services identification and data connectable to the smart device.

10. The content moderation application device of claim 9, wherein a secure cloud server is used for protection and security of streaming services identification and data.

11. The content moderation application device of claim 10, wherein data is stored and managed with a data management software or program.

12. The content moderation application device of claim 11 further comprising a plurality of indicia.

13. A content moderation application device that allows users to moderate content over multiple streaming services, the content moderation application device comprising:
a software application;
wherein the software application is accessible on a smart device;
wherein the software application allows a user to create a secure PIN;
wherein the software application allows a user to create filtered watchlists for children across various streaming platforms;
wherein the software application allows a user to create custom watchlists for different users;
wherein the software application allows users to block shows and streaming services, set screen time limits, set rating limits, and set a screen time tracker;
wherein the software application allows users to utilize several parameters to moderate content settings, such as specific streaming services, ratings, or genres; and
wherein a user utilizes the software application to moderate content universally over a plurality of streaming services.

14. The content moderation application device of claim 13, wherein the smart device is a smartphone, tablet, laptop, or a desktop computer.

15. The content moderation application device of claim 13, wherein the software application provides secure website or smart phone application access by users for content moderation.

16. The content moderation application device of claim 15 further comprising a web server and a Cloud database of streaming services identification and data connectable to the smart device.

17. The content moderation application device of claim 16, wherein a secure cloud server is used for protection and security of streaming services identification and data.

18. The content moderation application device of claim 17, wherein data is stored and managed with a data management software or program.

19. The content moderation application device of claim 13 further comprising a plurality of indicia.

20. A method of moderating content universally over a plurality of streaming services using a mobile application, the method comprising the following steps:
providing a content moderation application device comprising a software application or mobile application;
downloading or installing the software/mobile application on a smart device;
creating a secure PIN on the software/mobile application;
moderating content across multiple streaming services; and
creating customized watchlists for different users.
